(19) United States
(12) Patent Application Publication
(10) Pub. No.: US 2019/0108598 A1
(43) Pub. Date: Apr. 11, 2019

(54) SYSTEMS, METHODS, AND APPARATUSES FOR CREATING AND REUSING COMMUNITIES WITHIN A CLOUD BASED COMPUTING ENVIRONMENT

(71) Applicant: salesforce.com, Inc., San Francisco, CA (US)

(72) Inventors: Sanjaya Lai, Austin, TX (US); Khushwant Singh, San Ramon, CA (US); Peda Venkateswarlu Pola, Union City, CA (US); Joseph Shelby Hubick, Vancouver (CA)

(21) Appl. No.: 15/726,332

(22) Filed: Oct. 5, 2017

(51) Int. Cl. G06Q 50/00; G06F 17/30

(52) U.S. Cl. CPC G06Q 50/01; G06F 17/30292; G06F 17/30864

(57) ABSTRACT

Systems, methods, and apparatuses for creating and reusing communities within a cloud based computing environment. An exemplary system having at least a processor and a memory therein includes means for creating a first customized online community space within one of a number instances of a cloud computing environment, exporting the first customized online community space to multiple instances of the cloud computing environment, and creating a second customized online community space, separate and distinct from the first customized online community space, within one of the instances of the cloud computing environment, using the exported first customized online community space as a base for creating the second customized online community space.

### CLAIM OF PRIORITY

None.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments disclosed herein relate generally to the field of computing, and more particularly, to systems, methods, and apparatuses for creating and reusing communities within a cloud based computing environment such as a database system implementation supported by a processor and a memory to execute such functionality. Such means may be implemented within the computing architecture of a hosted computing environment, such as an on-demand or cloud-computing environment that utilizes multi-tenant database technologies, client-server technologies, traditional database technologies, or other computing architecture in support of the hosted computing environment.

### BACKGROUND

The subject matter discussed in this background section should not necessarily be construed as prior art merely because of its mention in this section. Similarly, a problem mentioned in this section or associated with the subject matter of this section should not be construed as being previously recognized in the prior art. The subject matter in this section merely represents different approaches, which in and of themselves may also correspond to claimed embodiments.

When one creates multiple online communities within the same instance of a cloud computing environment, or organization, even if those communities have many features in common, one must start from scratch when creating each community. This is also the case when the communities are deployed across or among different organizations. What is needed is a way to create and export a community that can be used to jump-start a new community, or package and distribute a community template that can be used to jump-start the new community for others in different organizations to use. Doing so saves time by building a community once and then reusing at least certain aspects of the community in creating one or more other communities.

The present state of the art may therefore benefit from the systems, methods, and apparatuses for creating and reusing communities within a cloud based computing environment as is described herein.

### BRIEF DESCRIPTION OF THE DRAWINGS

Embodiments are illustrated by way of example, and not by way of limitation, and will be more fully understood with reference to the following detailed description when considered in connection with the figures in which:

FIG. 1 depicts an exemplary architecture in accordance with described embodiments;

FIG. 2 depicts a flow diagram illustrating a method for creating and reusing communities within a cloud based computing environment in accordance with disclosed embodiments;

FIG. 3 depicts a flow diagram illustrating a method for creating and reusing communities within a cloud based computing environment in accordance with disclosed embodiments;

FIG. 4 depicts a flow diagram illustrating a method for creating and reusing communities within a cloud based computing environment in accordance with disclosed embodiments;

FIG. 5 depicts a user interface for use in creating and reusing communities within a cloud based computing environment in accordance with disclosed embodiments;

FIG. 6 depicts a user interface for use in creating and reusing communities within a cloud based computing environment in accordance with disclosed embodiments;

FIG. 7 depicts a user interface for use in creating and reusing communities within a cloud based computing environment in accordance with disclosed embodiments;

FIG. 8 depicts a user interface for use in creating and reusing communities within a cloud based computing environment in accordance with disclosed embodiments

FIG. 9 shows a diagrammatic representation of a system within which embodiments may operate, be installed, integrated, or configured;

FIG. 10A illustrates a block diagram of an environment in which an on-demand database service may operate in accordance with the described embodiments;

FIG. 10B illustrates another block diagram of an embodiment of elements of FIG. 10A and various possible interconnections between such elements in accordance with the described embodiments; and

FIG. 11 illustrates a diagrammatic representation of a machine in the exemplary form of a computer system, in accordance with one embodiment.

### DETAILED DESCRIPTION

Described herein are systems, methods, and apparatuses for creating and reusing communities within a cloud based computing environment. For instance, such an exemplary system, having a processor and a memory therein, creates a first industry-specific online community space within one of a number of instances of a cloud computing environment. The system then exports the first industry-specific online community space for reuse in multiple instances of the cloud computing environment. The system further creates a second industry-specific online community space, separate and distinct from the first industry-specific online community space, within one of instances of the cloud computing environment, using the exported first industry-specific online community space as a base for creating the second industry-specific online community space.

In the following description, numerous specific details are set forth such as examples of specific systems, languages, components, etc., in order to provide a thorough understanding of the various embodiments. It will be apparent, however, to one skilled in the art that these specific details need not be employed to practice the embodiments disclosed herein. In other instances, well-known materials or methods are described in detail in order to avoid unnecessarily obscuring the disclosed embodiments.

In addition to various hardware components depicted in the figures and described herein, embodiments further include various operations that are described below. The operations described in accordance with such embodiments may be performed by hardware components or may be embodied in machine-executable instructions, which may be used to cause a general-purpose or special-purpose processor programmed with the instructions to perform the operations. Alternatively, the operations may be performed by a combination of hardware and software.

Embodiments also relate to an apparatus for performing the operations disclosed herein. This apparatus may be specially constructed for the required purposes, or it may be a general purpose computer selectively activated, configured, or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems appears as set forth in the description below. In addition, embodiments are not described with reference to any particular programming language. It will be appreciated that a variety of programming languages may be used to implement the teachings of the embodiments as described herein.

Embodiments may be provided as a computer program product, or software, that may include a machine-readable medium having stored thereon instructions, which may be used to program a computer system (or other programmable electronic devices) to perform a process according to the disclosed embodiments. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical), etc.

Any of the disclosed embodiments may be used alone or together with one another in any combination. Although various embodiments may have been partially motivated by deficiencies with conventional techniques and approaches, some of which are described or alluded to within the specification, the embodiments need not necessarily address or solve any of these deficiencies, but rather, may address only some of the deficiencies, address none of the deficiencies, or be directed toward different deficiencies and problems which are not directly discussed.

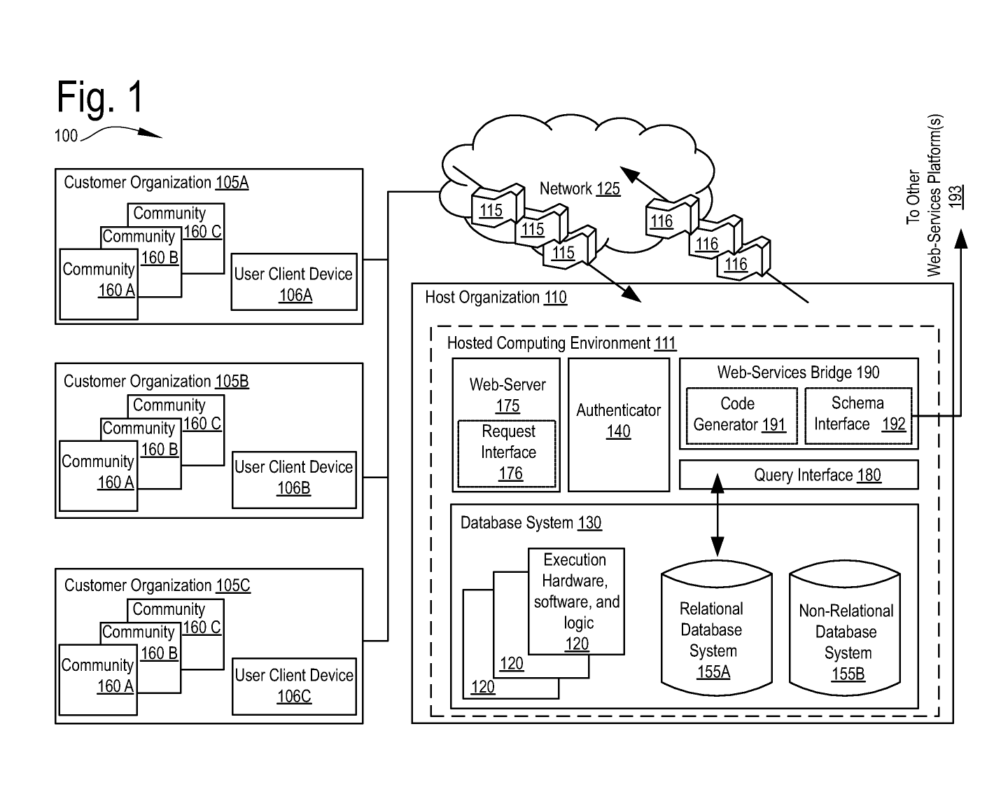

FIG. 1 depicts an exemplary architecture 100 in accordance with described embodiments. In one embodiment, a hosted computing environment 111 is communicably interfaced with a plurality of user client devices 106A-C (e.g., such as mobile devices, smart phones, tablets, PCs, etc.) through host organization 110. In one embodiment, a database system 130 includes databases 155A and 155B, for example, to store application code, object data, tables, datasets, and underlying database records with user data on behalf of client, or customer, organizations 105A-C, and communities 160A-C (e.g., users of such a database system 130 or tenants of a multi-tenant database type database system or the affiliated users of such a database system). Such databases include various database system types including, for example, a relational database system 155A and a non-relational database system 155B according to certain embodiments.

Certain embodiments may utilize a client-server computing architecture to supplement features, functionality, or computing resources for the database system 130 or alternatively, a computing grid, or a pool of work servers, or some combination of hosted computing architectures may be utilized to carry out the computational workload and processing demanded of the host organization 110 in conjunction with the database system 130.

The database system 130 depicted in the embodiment shown includes a plurality of underlying hardware, software, and logic elements 120 that implement database functionality and a code execution environment within the host organization 110.

In accordance with one embodiment, database system 130 utilizes the underlying database system implementations 155A and 155B to service database queries and other data interactions with the database system 130 that communicate with the database system 130 via the query interface. The hardware, software, and logic elements 120 of the database system 130 are separate and distinct from a plurality of customer organizations (105A, 105B, and 105C) which utilize web services and other service offerings as provided by the host organization 110 by communicably interfacing to the host organization 110 via network 125. In such a way, host organization 110 may implement on-demand services, on-demand database services or cloud computing services to subscribing customer organizations 105A-C.

Further depicted is the host organization 110 receiving input and other requests 115 from a plurality of customer organizations 105A-C via network 125 (such as a public Internet). For example, incoming search queries, database queries, API requests, interactions with displayed graphical user interfaces and displays at the user client devices 106A-C, or other inputs may be received from the customer organizations 105A-C to be processed against the database system 130, or such queries may be constructed from the inputs and other requests 115 for execution against the databases 155 or the query interface 180, pursuant to which results 116 are then returned to an originator or requestor, such as a user of one of a user client device 106A-C at a respective customer organization 105A-C.

In one embodiment, each customer organization 105A-C is an entity selected from the group consisting of: a separate and distinct remote organization, an organizational group within the host organization 110, a business partner of the host organization 110, or a customer organization 105A-C that subscribes to cloud computing services provided by the host organization 110.

In one embodiment, requests 115 are received at, or submitted to, a web-server 175 within host organization 110. Host organization 110 may receive a variety of requests for processing by the host organization 110 and its database system 130. Incoming requests 115 received at web-server 175 may specify which services from the host organization 110 are to be provided, such as query requests, search request, status requests, database transactions, graphical user interface requests and interactions, processing requests to retrieve, update, or store data on behalf of one of the customer organizations 105A-C, code execution requests, and so forth. Web-server 175 may be responsible for receiving requests 115 from various customer organizations 105A-C via network 125 on behalf of the query interface 180 and for providing a web-based interface or other graphical displays to an end-user user client device 106A-C or machine originating such data requests 115.

The query interface 180 is capable of receiving and executing requested queries against the databases and storage components of the database system 130 so as to return a result set, response, or other requested data in furtherance of the methodologies described. The query interface 180 additionally provides functionality to pass queries from web-server 175 into the database system 130 for execution against the databases 155 for processing search queries, or into the other available data stores of the host organization's computing environment 111. In one embodiment, the query interface 180 implements an Application Programming Interface (API) through which queries may be executed against the databases 155 or the other data stores.

Host organization 110 may implement a request interface 176 via web-server 175 or as a stand-alone interface to receive requests packets or other requests 115 from the user client devices 106A-C. Request interface 176 further supports the return of response packets or other replies and responses 116 in an outgoing direction from host organization 110 to the user client devices 106A-C.

Authenticator 140 operates on behalf of the host organization to verify, authenticate, and otherwise credential users attempting to gain access to the host organization.

Still further depicted within the hosted computing environment 111 is the web-services bridge 190 having therein both a code generator 191 and also a schema interface 192 (also referred to as an inter-agent schema interface) capable of communicating with other web-services environment(s) 193 which regardless of whether such web-services environments are hosted by the same host organizations 110 or hosted by different host organizations.

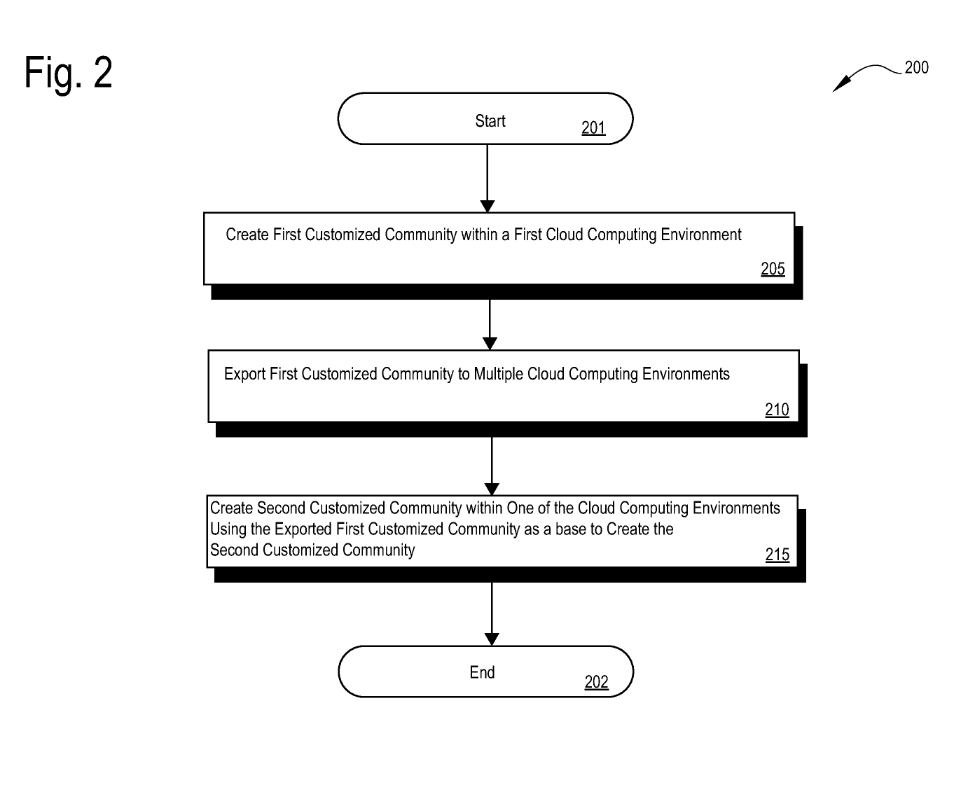

FIG. 2 depicts a flow diagram illustrating method 200 for creating and reusing customized communities 160A-C within a cloud based computing environment in accordance with the disclosed embodiments. Method 200 may be performed by processing logic that may include hardware (e.g., circuitry, dedicated logic, programmable logic, microcode, etc.) and software (e.g., instructions run on a processing device) to perform various operations such as designing, defining, retrieving, parsing, persisting, exposing, loading, executing, operating, receiving, generating, storing, maintaining, creating, returning, presenting, interfacing, communicating, transmitting, querying, processing, providing, determining, triggering, displaying, updating, sending, etc., in pursuance of the systems and methods as described herein. For example, the hosted computing environment 111, the web-services bridge 190, and its database system 130 as depicted at FIG. 1, and other systems and components as described herein may implement the described methodologies. Some of the blocks and/or operations listed below are optional in accordance with certain embodiments. The numbering of the blocks presented is for the sake of clarity and is not intended to prescribe an order of operations in which the various blocks must occur.

With reference to the method 200 depicted at FIG. 2, at block 205, processing logic creates a first customized online community space within a cloud computing environment, for example, community 160A. An online community space, or simply, a community, allows a person or company to share information and collaborate with people outside their company who are relevant to their business processes, such as customers or partners, via a website. In one embodiment, a community may be created using cloud-based community building software with point-and-click branding tools and community templates to create branded collaboration spaces, as further discussed below. Communities may also be referred to as web portals, portals, help forums, forums, customer support sites, support sites, etc. An environment or organization may have multiple communities 160A-C that each serve a different purpose or collaborate with a different group of people around a common mission or goal. A person or development team can create multiple communities within their organization for these different purposes. For example, one could create a customer support community to reduce support costs, or a channel sales community for partner deal support, or set up a community dedicated to an upcoming event. In one embodiment, the first customized community referenced in block 205 is any type of unique vertical industry business solution, industry-specific solution, or branded solution.

An instance of a cloud-based computing environment or “organization” (or, simply, “org”), in one embodiment, is a developer's Force.com platform environment, available from Salesforce. Development and deployment of a web application (“web app”) on Force.com typically takes place in an “environment” or “org”, which provides a number of features and services for applications within that environment. An environment lets a user, such as a developer, start developing, testing and deploying web applications in the cloud. Developer Edition (often referred to as a “DE org”), available from Salesforce.com, is a development environment with limits on data and users. Developer Edition, among other things, is used to isolate development and testing of web applications from a user's production or commercial environment. Independent Software Vendors (ISVs), or Systems Integrators (SIs), for example, may use DE orgs to create so-called “managed packages”, as discussed below, which later may be released as web apps on an electronic business application storefront, such as AppExchange, available from Salesforce, or later distributed to others via a private link, such as a uniform resource locator (URL) link, or other such address of the web app or web page, via which the web app may be accessed and executed.

A developer can get started with a cloud-based computing environment such as Force.com with just a computer, an internet connection, and a web browser. The application servers, web servers, databases, and the provisioning and configuration of these resources takes place in the cloud as needed, and as described herein. An environment lets a developer start developing and testing a cloud computing application without needing to configure or set up a single server. There are several types of environments available for developing and testing on Force.com. All environments can be accessed through a web browser, but some can also be accessed from the Force.com integrated developers environment (IDE), the Simple Object Access Protocol (SOAP) Application Programming Interface (API), and the Metadata API available from Salesforce.

At block 210, processing logic exports the first customized online community space to multiple instances of the cloud computing environment, including the environment in which the customized community was initially created. For example, community 160A is exported within Customer Organization 105A and also to Customer Organizations 105B and 105C. At block 215, processing logic creates a second customized online community space, separate and distinct from the first customized online community space, within one of the multiple instances of the cloud computing environment, using the exported first customized online community space as a base for creating the second customized online community space. In this manner, multiple customized online community spaces may be exported within the instance of the cloud computing environment, and/or across multiple other instances of the cloud computing environment. As an example, community space 160A may be used as a base for creating community space 160B, and/or community space 160C, in any one of Customer Organizations 105A-105C.

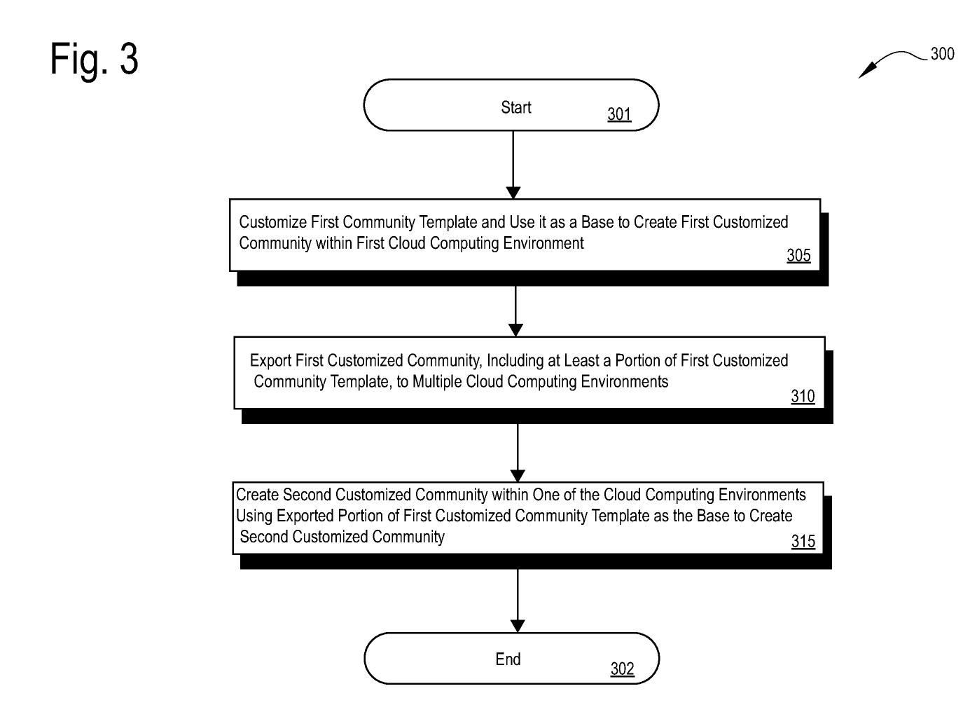

FIG. 3 depicts a flow diagram illustrating method 300 for creating and reusing customized communities within a cloud based computing environment in accordance with the disclosed embodiments. Method 300 may be performed by processing logic that may include hardware (e.g., circuitry, dedicated logic, programmable logic, microcode, etc.), software (e.g., instructions run on a processing device) to perform various operations such as designing, defining, retrieving, parsing, persisting, exposing, loading, executing, operating, receiving, generating, storing, maintaining, creating, returning, presenting, interfacing, communicating, transmitting, querying, processing, providing, determining, triggering, displaying, updating, sending, etc., in pursuance of the systems and methods as described herein.

With reference to FIG. 3, according to one embodiment of the method 300, a community such as community 160A, 160B or 160C, can be created and customized by processing logic at block 305 using a community template, or simply, a template. In one embodiment, a community can be created and customized using not only a community template but its related metadata as well. The template itself may also be customized and used as a base to create the first customized community within the first cloud computing environment. Generally speaking, a template may be thought of as a master web page used to produce other web pages. However, the principle applies to the many other components and features that may exist in a template or community based on such. The template used to create a community may be an out-of-the-box, or off-the-shelf template, such as the Customer Service template, also known as Napili, or the Partner Central template, both available from Salesforce.

The Customer Service template allows for users to post questions to a community, search for and view articles, collaborate, and contact support agents by creating cases. This template supports creating customized solutions that may be exported and distributed or packaged and uploaded to an electronic storefront for business applications. In particular, the template supports custom user-interface theme layout components, cascaded style sheets (CSSs), web pages, and content layouts, which allow a developer to transform the look and feel of the community template. The Partner Central template is a template designed for channel or third-party sales. It is designed for a company to recruit, build, and grow a partner network to drive channel sales and marketing together in a branded online space. The template provides for lead distribution, deal registration, and marketing campaigns, or sharing training materials and sales collateral in a central space, and use reports to track activities.

In one embodiment, processing logic at block 305 creates a customized community template within the first instance of a cloud computing environment. In one embodiment, a developer creates a customized Salesforce Lightning community, using Lightning components and templates such as the Customer Service template, Napili, described above, to share features and data from the first cloud computing environment with others (customers, employees, partners, distributors, resellers, suppliers, etc.) in the same or different cloud computing environment. Salesforce Lightning includes a user-interface (UI) framework for developing dynamic web apps for mobile and desktop devices, known as the Lightning Component Framework, and developer tools.

The Lightning Component UI framework allows for building single-page applications. The framework supports partitioned, multi-tier component development that bridges the client and server. It uses JavaScript on the client side and Apex on the server side. The benefits of using the framework include an out-of-the-box set of components and interfaces, an event-driven architecture, and a framework optimized for performance. The term component is defined herein as a self-contained and reusable unit of an application, which represents a reusable section of the user interface (UI). Components can range in granularity from a single line of text to an entire application.

The Lightning Component framework includes a set of prebuilt components. For example, components that come with Salesforce's Lightning Design System (SLDS) styling are available in the lightning namespace and are known as the base Lightning components. One can assemble and configure the components to form new components in an application. Components are rendered to produce hypertext markup language (HTML) document object model (DOM) elements within a browser. A component can contain other components, along with HTML, cascaded style sheets (CSS), JavaScript, Apex controllers, or any other web-enabled code, which enables building apps with sophisticated UIs.

In one embodiment, the details of a component's implementation are encapsulated. Encapsulation allows a consumer of a component to focus on building an application, while the component author can continue to customize and make changes without breaking consumers' applications. Components are configured by setting named attributes that are exposed in their definition. Components interact with their environment by listening to or publishing events.

With respect to events, many languages and frameworks use event-driven programming, such as JavaScript and Java Swing. Handlers respond to interface events as they occur. A component registers that it might fire an event in its markup language. Events are fired from JavaScript controller actions that are typically triggered by a user interacting with the user interface.

The Lightning Component framework has two types of events: component events that are handled by the component itself or a component that instantiates or contains the component, and application events that are handled by all components that are listening to the event. These events are essentially a traditional publish-subscribe model.

The Lightning Component Framework also supports interfaces. Object-oriented languages, such as Java, support the concept of an interface that defines a set of method signatures. A class that implements the interface provides the method implementations. An interface in Java cannot be instantiated directly, but a class that implements the interface can. Similarly, the Lightning Component framework supports the concept of interfaces that define a component's shape by defining its attributes.

In one embodiment, the Lightning Component framework is built on the open source Aura framework. The Aura framework enables building apps independent of data in the environment. The Aura framework is available at https://github.com/forcedotcom/aura.

The developer tools referred to above include, for example, the Lightning App Builder, available from Salesforce, which allows building apps visually, without code, using off-the-shelf and custom-built Lighting components, and Community Builder, also available from Salesforce, which is used to design and build communities using Lightning templates and components. Just like the Lightning App Builder, one can use standard or custom components to create community pages with point-and-click customizations.

Processing logic at block 305, in one embodiment, creates a customized Lightning community template within the first cloud computing environment. In particular, processing logic allows one to customize the look and feel of a Lightning community template in several ways, each of varying complexity and granularity. Within Community Builder, styles that are specific to the template may be customized. A branding panel may be used to update the template with simple, point-and-click branding properties. A CSS editor may be used to create a custom CSS that overrides the basic styles of template elements.

In one embodiment, to more fully customize the appearance of a template, processing logic at block 305 allows for building unique components. Custom Lightning components encapsulate a CSS resource as part of the component bundle, making the components reusable across communities. Content layout components define the content regions of a web page and contain components. Theme layout components allow for customizing the structural layout of the template, such as the header and footer, and override its default styles.

In one embodiment, processing logic at block 305 allows for integration of cloud computing customer relationship management (CRM) applications, such as available from Salesforce, and business logic.

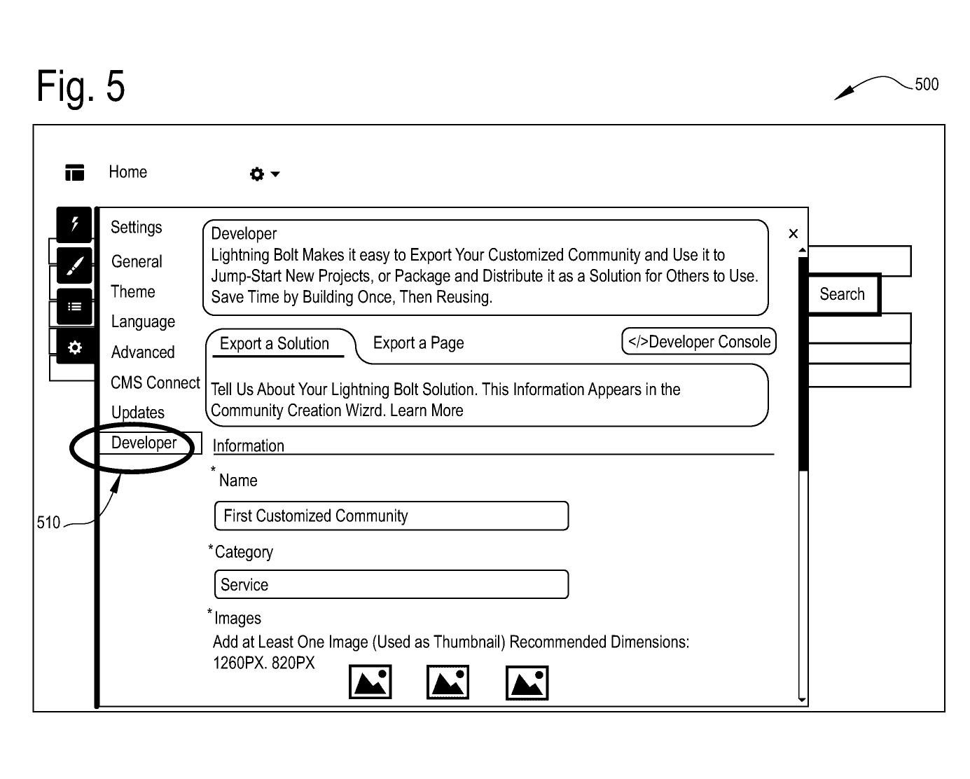

Once the first customized community template is created and used as a base to create the first customized community (e.g., community 160A) within the first cloud computing environment (e.g., Customer Organization 105A), processing logic at block 310 provides for exporting the first customized community and/or the first customized community template, or at least a portion of the customized community template. For example, a single page of the first customized community template may be exported. The first customized community, including the at least portion of the first customized community template, is exported to multiple cloud computing environments, according to one embodiment. In one embodiment, a Salesforce Lightning template may be used as a base to build a custom solution with standard pages and components, or to create custom pages, layouts, and components. After customizing the template is finished, the template or one of its pages is exported. With reference to FIG. 5, in one embodiment 500, the template is customized using Salesforce's Community Builder application accessible in the developer's environment. The customized template is then exported from the Settings|Developer at 510 to make it ready to use or distribute. In one embodiment, the exported template name must be unique. The template author's organization name is also shown within the author's own organization. In one embodiment, the exported template and its “artifacts” are accessible via Salesforce's Metadata API.

As an example of exporting, a developer customizes the Salesforce Partner Central template to create a community with features that meet particular business needs. The developer wants to create several similar partner communities, but does not want to build each one from scratch. By exporting the customized solution, it can be reused to build as many communities as needed. As another example, a consulting partner specializes in building communities for the real estate industry. According to one embodiment that uses Salesforce's Lightning Bolt, the consulting partner can build and export a real-estate-focused solution to distribute to customers. After the template is installed on a customer's organization, it can further customize to suit their unique needs. By building the bulk of the solution in the consulting partner's organization and then distributing it to customers' organizations, their communities can be launched more easily and more quickly. As a final example, an ISV builds a custom page and several custom Salesforce Lightning components to create an e-commerce feature for use in Salesforce's Community Builder application. The page and its components can then be bundled into a single package and distributed to customers.

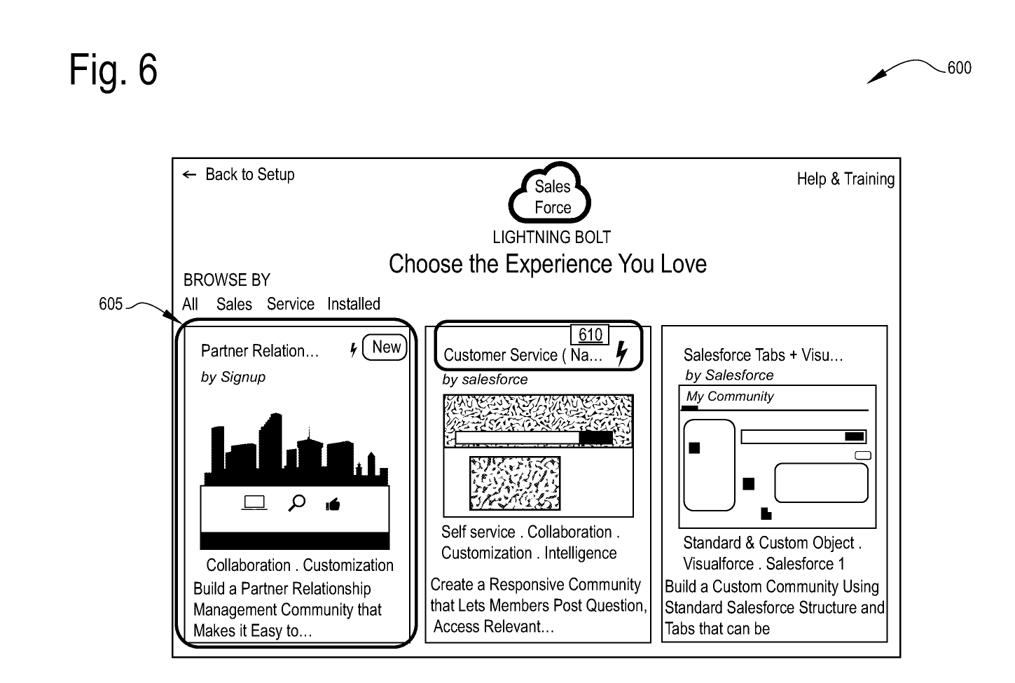

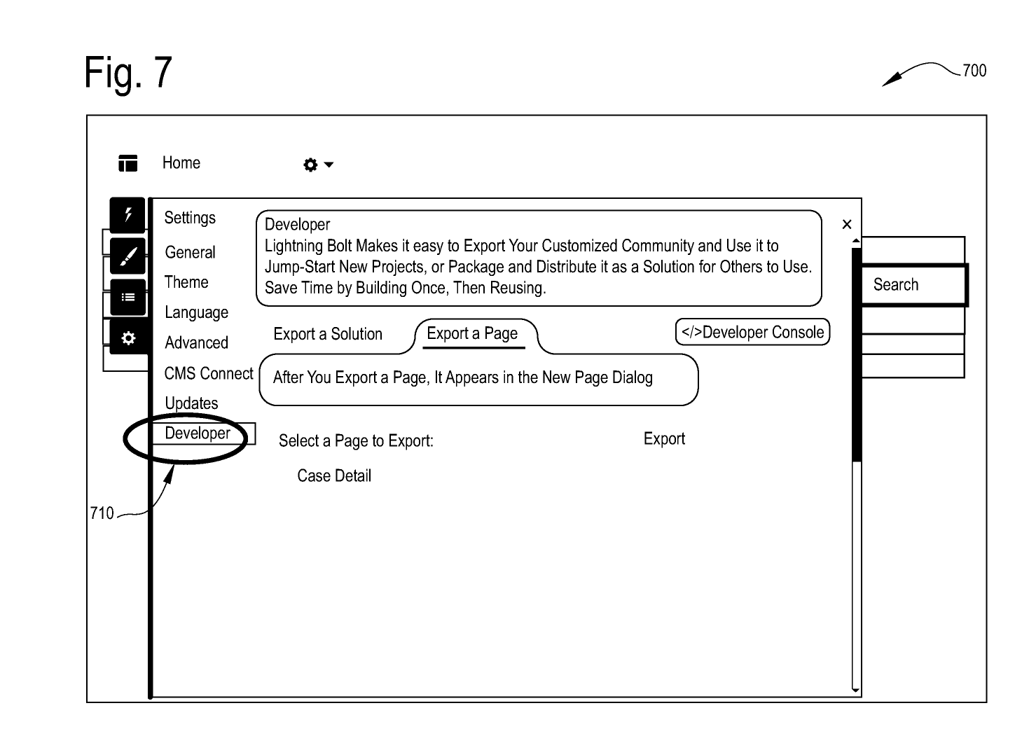

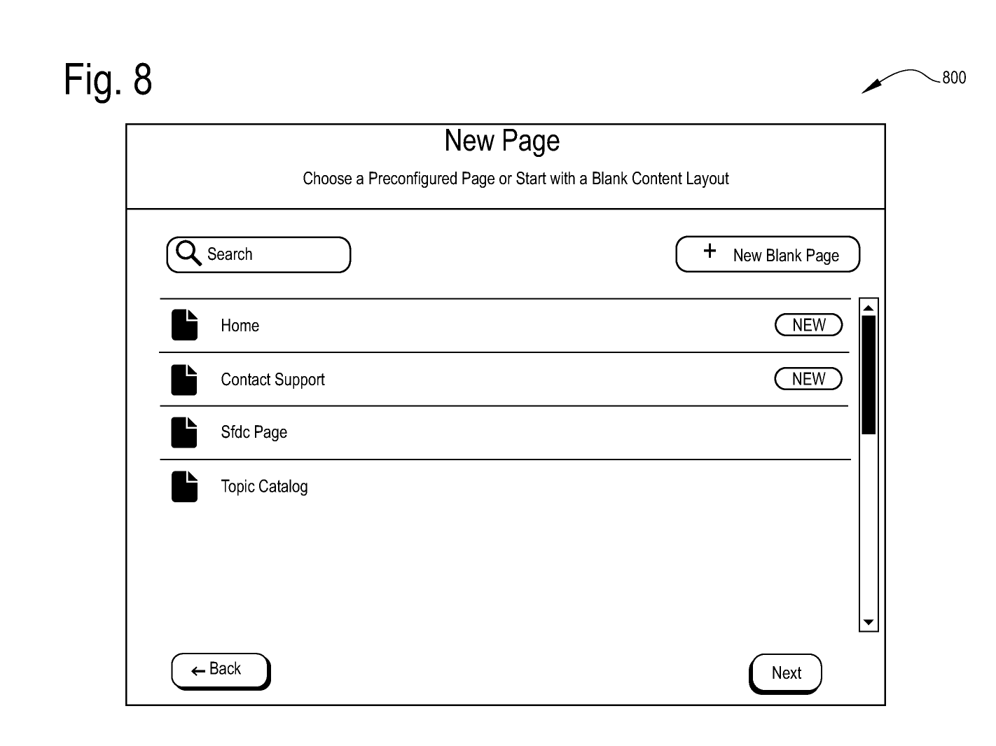

With reference to FIG. 6, according to one embodiment 600 that uses Salesforce's Lightning Bolt, when a template is exported, it appears in a Community Creation wizard in the first cloud computing environment. The author can then use it as a base for building new communities. Alternatively, the author may package the solution and install it in another cloud computing environment or organization, in which case the packaged solution appears in that organization's Community Creation wizard, as further discussed below. As an example, templates 605 and 610, depicted in FIG. 6, have been exported and appear in the Community Creation wizard 600 in the first cloud computing environment, where it can be used to build new communities. Similarly, a single page may be exported, as depicted at 700 in FIG. 7. The exporting of the single page includes exporting the page's content layout and components. After the page is exported, it appears in a New Page dialog box in all communities in the first cloud computing environment, in one embodiment. Alternatively, if the author packages the page and installs it in another cloud computing environment, it appears in the New Page dialog box of that org, as depicted at 800 in FIG. 8. Newly installed pages are highlighted as New for 30 days, in one embodiment.

At block 315, processing logic creates a second customized online community space (e.g., community 160B) separate and distinct from the first customized online community space, within one of the number of instances of the cloud computing environment (e.g., any one of Customer Organizations 105A-105C), using at least a portion, e.g., a single page, of the exported first customized template as a base for creating the second customized online community space. Thus, multiple customized online community spaces may exist within the instance of the cloud computing environment, and/or across multiple instances of the cloud computing environment.

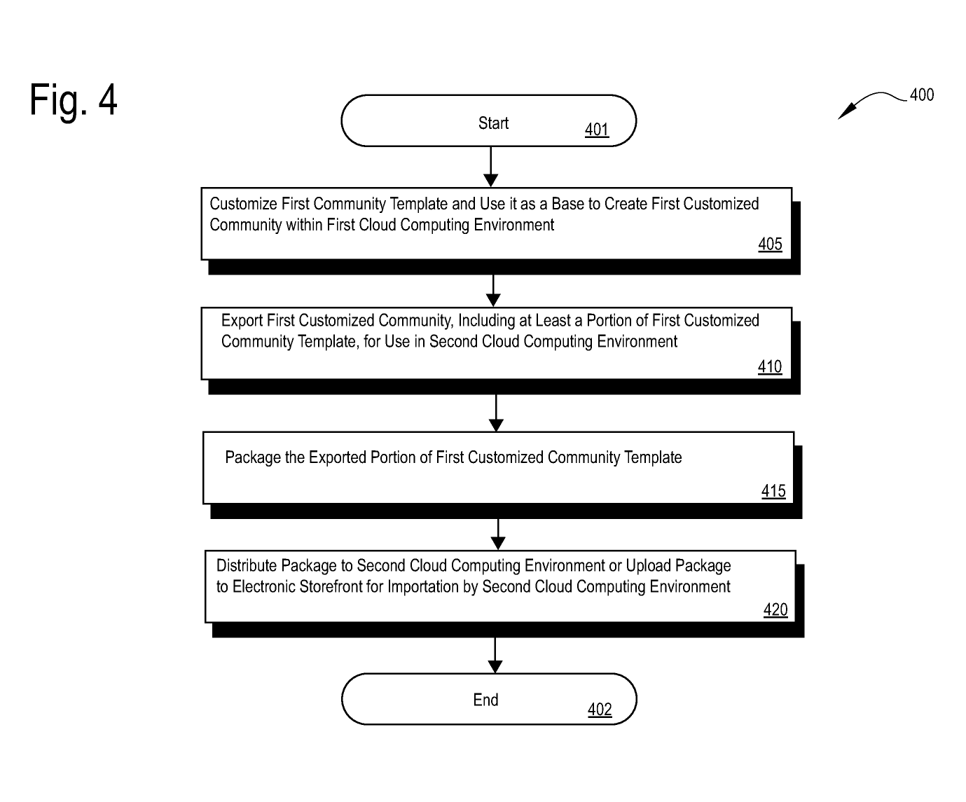

FIG. 4 depicts a flow diagram illustrating method 400 for creating and reusing customized communities within a cloud based computing environment in accordance with the disclosed embodiments. Method 400 may be performed by processing logic that may include hardware (e.g., circuitry, dedicated logic, programmable logic, microcode, etc.), software (e.g., instructions run on a processing device) to perform various operations such as designing, defining, retrieving, parsing, persisting, exposing, loading, executing, operating, receiving, generating, storing, maintaining, creating, returning, presenting, interfacing, communicating, transmitting, querying, processing, providing, determining, triggering, displaying, updating, sending, etc., in pursuance of the systems and methods as described herein.

With reference to FIG. 4, according to one embodiment of the method 400, a community can be created and customized by processing logic at block 405 using a community template. The template itself may also be customized and used as a base to create the first customized community within the first cloud computing environment. Once the first customized community template is created and used as a base to create the first customized community with the first cloud computing environment, processing logic at block 410 provides for exporting the first customized community and/or the first customized community template, or at least a portion of the customized community template, for example, a exporting a single page of the first customized community template. The first customized community, including the at least portion of the first customized community template, is exported for use in another cloud computing environment, separate and distinct from the first cloud computing environment, according to one embodiment. Once the first customized community template is exported, is it packaged for distribution to the second cloud computing environment by processing logic at block 415. A developer can package solutions for distribution to customers' organizations. A package is simply a container for something as small as an individual component or as large as a set of related applications. It contains components such as applications, objects, reports, or email templates. Packages come in two forms, unmanaged and managed, wherein managed packages avoid naming conflicts with other packages in a customer's organization or the developer's or author's own environment. A managed package, according to one embodiment, may be creating using a Developer Edition “org” (cloud computing environment) available from Salesforce.

After the developer creates and uploads a managed package, according to processing logic at block 420, the developer may privately share a link, for example, a uniform resource locator (URL) link, or an address specified using some other such protocol for specifying addresses on the Internet, with clients, customers, or partners. In an alternative embodiment, the developer may publish the managed package to an electronic business app storefront. In one embodiment, the developer publishes or lists a custom Salesforce Lightning Bolt solution as a managed package to Salesforces' Force.com AppExchange business application store. The developer can market the solution with an AppExchange listing in the same way any other app, component, or consulting service are listed: describe the solution, pricing, support, and other details so that customers can determine whether the offer of the solution is right for them.

Once the exported template or portion thereof of the first customized community template is distributed by processing logic at block 420, a customer in another cloud computing environment may create a second customized community within their environment using the exported template as a base to create the second customized community. This reuse of the exported template lessens the time and costs associated with creating the second customized community since it does not need to be created from scratch.

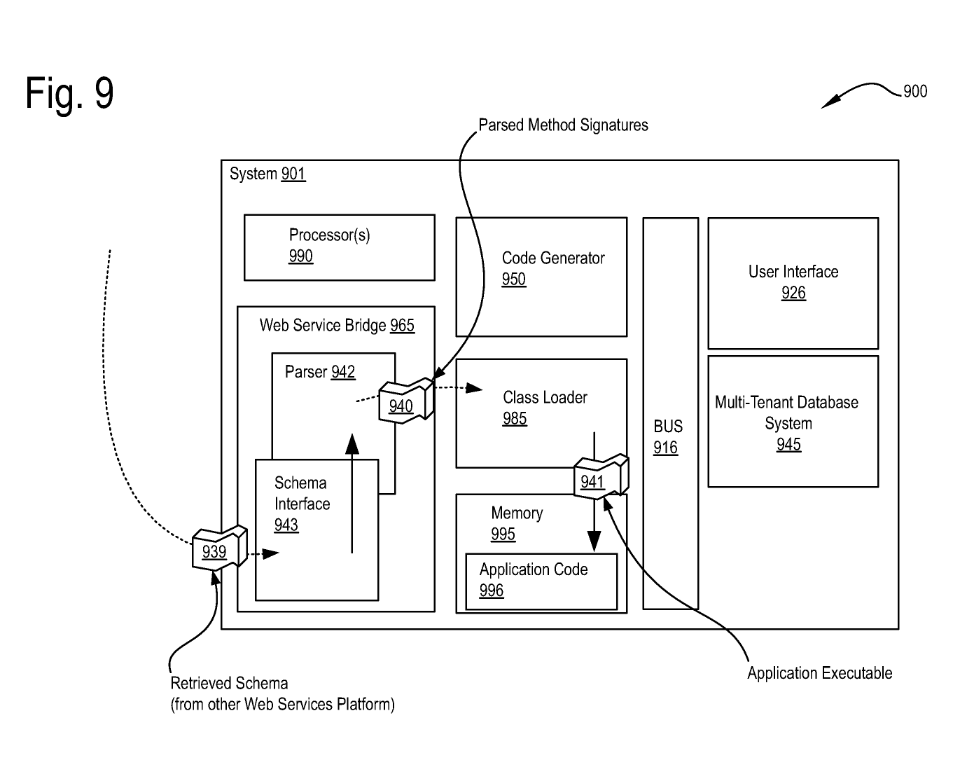

FIG. 9 shows a diagrammatic representation of a system 901 within which embodiments may operate, be installed, integrated, or configured. In accordance with one embodiment, there is a system 901 having at least a processor 990 and a memory 995 therein to execute implementing application code 996. Such a system 901 may communicatively interface with and cooperatively execute with the benefit of a hosted computing environment, such as a host organization, a multi-tenant environment, an on-demand service provider, a cloud based service provider, a client-server environment, etc.

According to the depicted embodiment, the system 901, which may operate within a host organization, includes the processor 990 and the memory 995 to execute instructions at the system 901. According to such an embodiment, the system 901 further includes means for creating a first industry-specific online community space within one of a number instances of a cloud computing environment, exporting the first industry-specific online community space to multiple instances of the cloud computing environment, and creating a second industry-specific online community space, separate and distinct from the first industry-specific online community space, within one of instances of the cloud computing environment, using the exported first industry-specific online community space as a base for creating the second industry-specific online community space.

According to another embodiment of the system 901, a user interface 926 operates at a user client device remote from the system and communicatively interfaces with the system via a public Internet; in which the system operates at a host organization as a cloud based service provider to the user client device; in which the cloud based service provider hosts request interface exposed to the user client device via the public Internet, in which the request interface receives inputs from the client device to design the application as a request for services from the cloud based service provider.

Bus 916 interfaces the various components of the system 901 amongst each other, with any other peripheral(s) of the system 901, and with external components such as external network elements, other machines, client devices, cloud computing services, etc. Communications may further include communicating with external devices via a network interface over a LAN, WAN, or the public Internet.

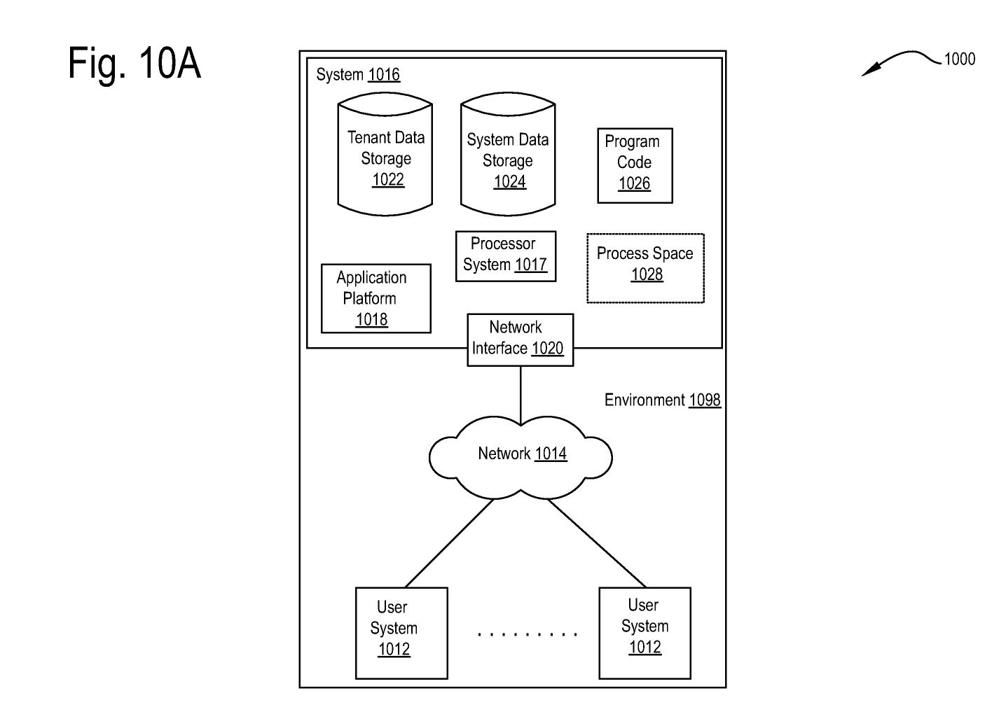

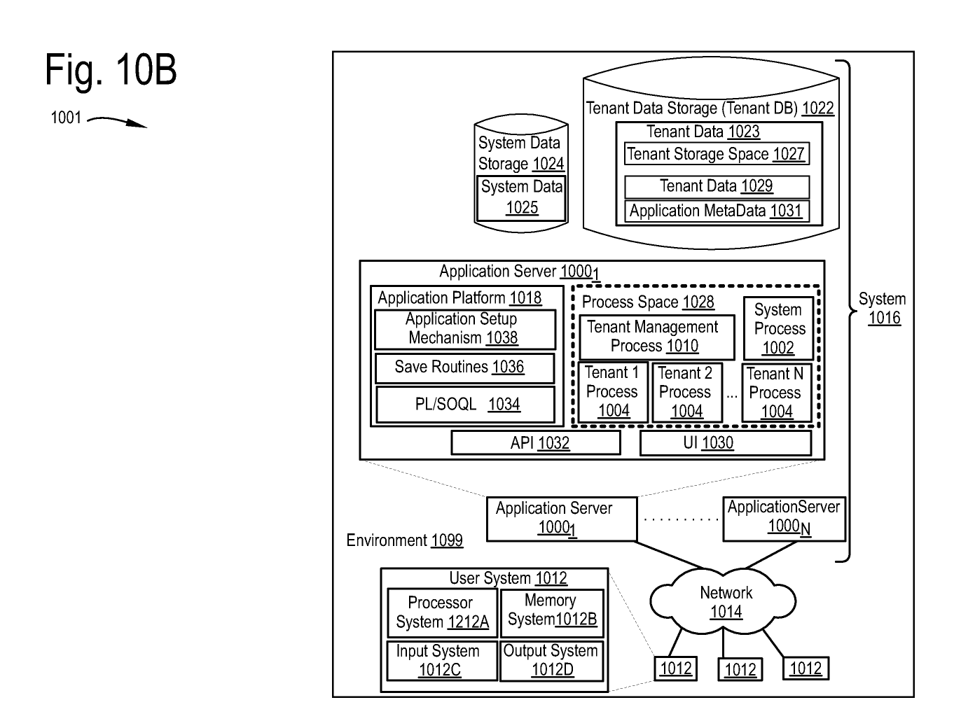

FIG. 10A illustrates a block diagram of an environment 1098 in which an on-demand database service may operate in accordance with the described embodiments. Environment 1098 may include user systems 1012, network 1014, system 1016, processor system 1017, application environment 1018, network interface 1020, tenant data storage 1022, system data storage 1024, program code 1026, and process space 1028. In other embodiments, environment 1098 may not have all of the components listed and/or may have other elements instead of, or in addition to, those listed above.

Environment 1098 is an environment in which an on-demand database service exists. User system 1012 may be any machine or system that is used by a user to access a database user system. For example, any of user systems 1012 can be a handheld computing device, a mobile phone, a laptop computer, a work station, and/or a network of computing devices. As illustrated in FIG. 10A (and in more detail in FIG. 10B) user systems 1012 might interact via a network 1014 with an on-demand database service, which is system 1016.

An on-demand database service, such as system 1016, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 1016” and “system 1016” is used interchangeably herein. A database image may include one or more database objects. A relational database management system (RDMS) or the equivalent may execute storage and retrieval of information against the database object(s). Application environment 1018 may be a framework that allows the applications of system 1016 to run, such as the hardware and/or software, e.g., the operating system. In an embodiment, on-demand database service 1016 may include an application environment 1018 that enables creation, managing and executing one or more applications developed by the provider of the on-demand database service, users accessing the on-demand database service via user systems 1012, or third party application developers accessing the on-demand database service via user systems 1012.

The users of user systems 1012 may differ in their respective capacities, and the capacity of a particular user system 1012 might be entirely determined by permissions (permission levels) for the current user. For example, where a salesperson is using a particular user system 1012 to interact with system 1016, that user system has the capacities allotted to that salesperson. However, while an administrator is using that user system to interact with system 1016, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 1014 is any network or combination of networks of devices that communicate with one another. For example, network 1014 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it is understood that the networks that the claimed embodiments may utilize are not so limited, although TCP/IP is a frequently implemented protocol.

User systems 1012 might communicate with system 1016 using TCP/IP and, at a higher network level, use other common Internet protocols to communicate, such as HTTP, FTP, AFS, WAP, etc. In an example where HTTP is used, user system 1012 might include an HTTP client commonly referred to as a “browser” for sending and receiving HTTP messages to and from an HTTP server at system 1016. Such an HTTP server might be implemented as the sole network interface between system 1016 and network 1014, but other techniques might be used as well or instead. In some implementations, the interface between system 1016 and network 1014 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 1016, shown in FIG. 10A, implements a web-based customer relationship management (CRM) system. For example, in one embodiment, system 1016 includes application servers configured to implement and execute CRM software applications as well as provide related data, code, forms, webpages and other information to and from user systems 1012 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 1016 implements applications other than, or in addition to, a CRM application. For example, system 1016 may provide tenant access to multiple hosted (standard and custom) applications, including a CRM application. User (or third party developer) applications, which may or may not include CRM, may be supported by the application environment 1018, which manages creation, storage of the applications into one or more database objects and executing of the applications in a virtual machine in the process space of the system 1016.

One arrangement for elements of system 1016 is shown in FIG. 10A, including a network interface 1020, application environment 1018, tenant data storage 1022 for tenant data 1023, system data storage 1024 for system data 1025 accessible to system 1016 and possibly multiple tenants, program code 1026 for implementing various functions of system 1016, and a process space 1028 for executing MTS system processes and tenant-specific processes, such as running applications as part of an application hosting service. Additional processes that may execute on system 1016 include database indexing processes.

Several elements in the system shown in FIG. 10A include conventional, well-known elements that are explained only briefly here. For example, each user system 1012 may include a desktop personal computer, workstation, laptop, PDA, cell phone, or any wireless access protocol (WAP) enabled device or any other computing device capable of interfacing directly or indirectly to the Internet or other network connection. User system 1012 typically runs an HTTP client, e.g., a browsing program, such as Microsoft's Internet Explorer browser, a Mozilla or Firefox browser, an Opera, or a WAP-enabled browser in the case of a smartphone, tablet, PDA or other wireless device, or the like, allowing a user (e.g., subscriber of the multi-tenant database system) of user system 1012 to access, process and view information, pages and applications available to it from system 1016 over network 1014. Each user system 1012 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 1016 or other systems or servers. For example, the user interface device can be used to access data and applications hosted by system 1016, and to perform searches on stored data, and otherwise allow a user to interact with various GUI pages that may be presented to a user. As discussed above, embodiments are suitable for use with the Internet, which refers to a specific global internetwork of networks. However, it is understood that other networks can be used instead of the Internet, such as an intranet, an extranet, a virtual private network (VPN), a non-TCP/IP based network, any LAN or WAN or the like.

According to one embodiment, each user system 1012 and all of its components are operator configurable using applications, such as a browser, including computer code run using a central processing unit such as an Intel Pentium® processor or the like. Similarly, system 1016 (and additional instances of an MTS, where more than one is present) and all of their components might be operator configurable using application(s) including computer code to run using a central processing unit such as processor system 1017, which may include an Intel Pentium® processor or the like, and/or multiple processor units.

According to one embodiment, each system 1016 is configured to provide webpages, forms, applications, data and media content to user (client) systems 1012 to support the access by user systems 1012 as tenants of system 1016. As such, system 1016 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS may include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It is understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 10B illustrates another block diagram of an embodiment of elements of FIG. 10A and various possible interconnections between such elements in accordance with the described embodiments. FIG. 10B also illustrates environment 1099. However, in FIG. 10B, the elements of system 1016 and various interconnections in an embodiment are illustrated in further detail. More particularly, FIG. 10B shows that user system 1012 may include a processor system 1012A, memory system 1012B, input system 1012C, and output system 1012D. FIG. 10B shows network 1014 and system 1016. FIG. 10B also shows that system 1016 may include tenant data storage 1022, having therein tenant data 1023, which includes, for example, tenant storage space 1027, tenant data 1029, and application metadata 1031. System data storage 1024 is depicted as having therein system data 1025. Further depicted within the expanded detail of application servers 1000_{1-N} are User Interface (UI) 1030, Application Program Interface (API) 1032, application environment 1018 includes PL/SOQL 1034, save routines 1036, application setup mechanism 1038, process space 1028 includes system process space 1002, tenant 1-N process spaces 1004, and tenant management process space 1010. In other embodiments, environment 1099 may not have the same elements as those listed above and/or may have other elements instead of, or in addition to, those listed above.

User system 1012, network 1014, system 1016, tenant data storage 1022, and system data storage 1024 were discussed above in FIG. 10A. As shown by FIG. 10B, system 1016 may include a network interface 1020 (of FIG. 10A) implemented as a set of HTTP application servers 1000, an application environment 1018, tenant data storage 1022, and system data storage 1024. Also shown is system process space 1002, including individual tenant process spaces 1004 and a tenant management process space 1010. Each application server 1000 may be configured to tenant data storage 1022 and the tenant data 1023 therein, and system data storage 1024 and the system data 1025 therein to serve requests of user systems 1012. The tenant data 1023 might be divided into individual tenant storage areas (e.g., tenant storage space 1027), which can be either a physical arrangement and/or a logical arrangement of data. Within each tenant storage space 1027, tenant data 1029, and application metadata 1031 might be similarly allocated for each user. For example, a copy of a user's most recently used (MRU) items might be stored to tenant data 1029. Similarly, a copy of MRU items for an entire organization that is a tenant might be stored to tenant storage space 1027. A UI 1030 provides a user interface and an API 1032 provides an application programmer interface into system 1016 resident processes to users and/or developers at user systems 1012. The tenant data and the system data may be stored in various databases, such as one or more Oracle™ databases.

Application environment 1018 includes an application setup mechanism 1038 that supports application developers' creation and management of applications, which may be saved as metadata into tenant data storage 1022 by save routines 1036 for execution by subscribers as one or more tenant process spaces 1004 managed by tenant management process space 1010 for example. Invocations to such applications may be coded using PL/SOQL 1034 that provides a programming language style interface extension to API 1032. Invocations to applications may be detected by one or more system processes, which manages retrieving application metadata 1031 for the subscriber making the invocation and executing the metadata as an application in a virtual machine.

Each application server 1000 may be communicably coupled to database systems, e.g., having access to system data 1025 and tenant data 1023, via a different network connection. For example, one application server 1000i might be coupled via the network 1014 (e.g., the Internet), another application server 1000N-1 might be coupled via a direct network link, and another application server 1000N might be coupled by yet a different network connection. Transfer Control Protocol and Internet Protocol (TCP/IP) are typical protocols for communicating between application servers 1000 and the database system. However, it will be apparent to one skilled in the art that other transport protocols may be used to optimize the system depending on the network interconnect used.

In certain embodiments, each application server 1000 is configured to handle requests for any user associated with any organization that is a tenant. Because it is desirable to be able to add and remove application servers from the server pool at any time for any reason, there is preferably no server affinity for a user and/or organization to a specific application server 1000. In one embodiment, therefore, an interface system implementing a load balancing function (e.g., an F5 Big-IP load balancer) is communicably coupled between the application servers 1000 and the user systems 1012 to distribute requests to the application servers 1000. In one embodiment, the load balancer uses a least connections algorithm to route user requests to the application servers 1000. Other examples of load balancing algorithms, such as round robin and observed response time, also can be used. For example, in certain embodiments, three consecutive requests from the same user may hit three different application servers 1000, and three requests from different users may hit the same application server 1000. In this manner, system 1016 is multi-tenant, in which system 1016 handles storage of, and access to, different objects, data and applications across disparate users and organizations.

As an example of storage, one tenant might be a company that employs a sales force where each salesperson uses system 1016 to manage their sales process. Thus, a user might maintain contact data, leads data, customer follow-up data, performance data, goals and progress data, etc., all applicable to that user's personal sales process (e.g., in tenant data storage 1022). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 1016 that are allocated at the tenant level while other data structures might be managed at the user level. Because an MTS might support multiple tenants including possible competitors, the MTS may have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 1016 might also maintain system level data usable by multiple tenants or other data. Such system level data might include industry reports, news, postings, and the like that are sharable among tenants.

In certain embodiments, user systems 1012 (which may be client systems) communicate with application servers 1000 to request and update system-level and tenant-level data from system 1016 that may require sending one or more queries to tenant data storage 1022 and/or system data storage 1024. System 1016 (e.g., an application server 1000 in system 1016) automatically generates one or more SQL statements (e.g., one or more SQL queries) that are designed to access the desired information. System data storage 1024 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects as described herein. It is understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It is understood that the word “entity” may also be used interchangeably herein with “object” and “table.”

In some multi-tenant database systems, tenants may be allowed to create and store custom objects, or they may be allowed to customize standard entities or objects, for example by creating custom fields for standard objects, including custom index fields. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

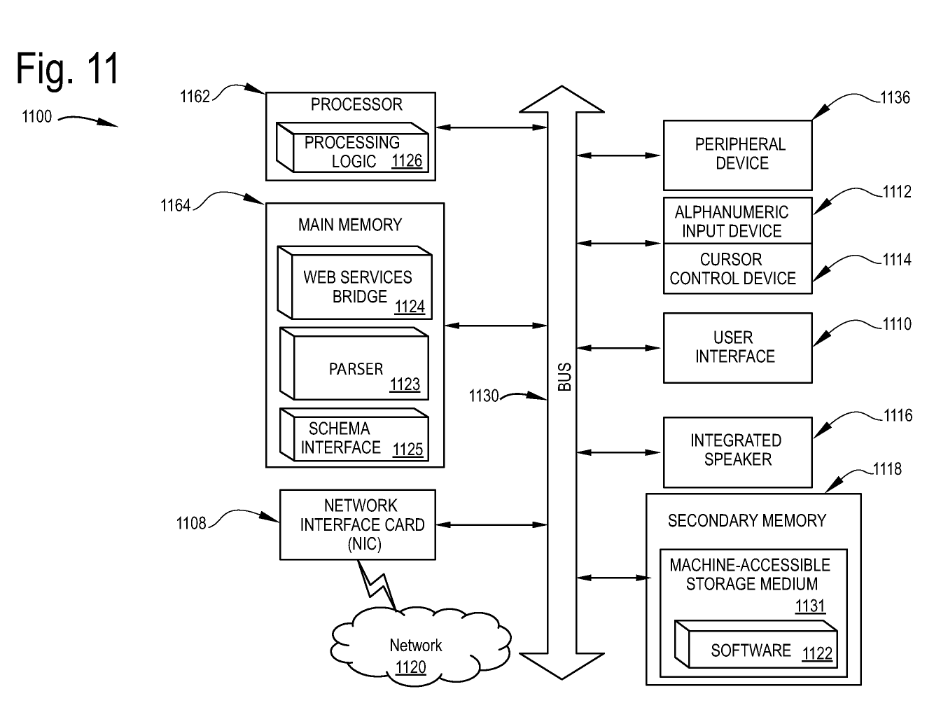

FIG. 11 illustrates a diagrammatic representation of a machine 1100 in the exemplary form of a computer system, in accordance with one embodiment, within which a set of instructions, for causing the machine/computer system 1100 to perform any one or more of the methodologies discussed herein, may be executed. In alternative embodiments, the machine may be connected (e.g., networked) to other machines in a Local Area Network (LAN), an intranet, an extranet, or the public Internet. The machine may operate in the capacity of a server or a client machine in a client-server network environment, as a peer machine in a peer-to-peer (or distributed) network environment, as a server or series of servers within an on-demand service environment. Certain embodiments of the machine may be in the form of a personal computer (PC), a tablet PC, a set-top box (STB), a Personal Digital Assistant (PDA), a cellular telephone, a web appliance, a server, a network router, switch or bridge, computing system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 1100 includes a processor 1102, a main memory 1104 (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), volatile but high-data rate RAM, etc.), and a secondary memory 1118 (e.g., a persistent storage device including hard disk drives and a persistent database and/or a multi-tenant database implementation), which communicate with each other via a bus 1130. Main memory 1104 includes a web services bridge 1124 and a schema interface 1125 and a parser 1123 by which to communicate with another web services environment, retrieve, and parse a schema to identify methods provided by the web service at the other web services environment in accordance with described embodiments. Main memory 1104 and its sub-elements are operable in conjunction with processing logic 1126 and processor 1102 to perform the methodologies discussed herein.

Processor 1102 represents one or more general-purpose processing devices such as a microprocessor, central processing unit, or the like. More particularly, the processor 1102 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 1102 may also be one or more special-purpose processing devices such as an application specific integrated circuit (ASIC), a field programmable gate array (FPGA), a digital signal processor (DSP), network processor, or the like. Processor 1102 is configured to execute the processing logic 1126 for performing the operations and functionality which is discussed herein.

The computer system 1100 may further include a network interface card 1108. The computer system 1100 also may include a user interface 1110 (such as a video display unit, a liquid crystal display, etc.), an alphanumeric input device 1112 (e.g., a keyboard), a cursor control device 1114 (e.g., a mouse), and a signal generation device 1116 (e.g., an integrated speaker). The computer system 1100 may further include peripheral device 1136 (e.g., wireless or wired communication devices, memory devices, storage devices, audio processing devices, video processing devices, etc.).

The secondary memory 1118 may include a non-transitory machine-readable storage medium or a non-transitory computer readable storage medium or a non-transitory machine-accessible storage medium 1131 on which is stored one or more sets of instructions (e.g., software 1122) embodying any one or more of the methodologies or functions described herein. The software 1122 may also reside, completely or at least partially, within the main memory 1104 and/or within the processor 1102 during execution thereof by the computer system 1100, the main memory 1104 and the processor 1102 also constituting machine-readable storage media. The software 1122 may further be transmitted or received over a network 1120 via the network interface card 1108.

While the subject matter disclosed herein has been described by way of example and in terms of the specific embodiments, it is to be understood that the claimed embodiments are not limited to the explicitly enumerated embodiments disclosed. To the contrary, the disclosure is intended to cover various modifications and similar arrangements as are apparent to those skilled in the art. Therefore, the scope of the appended claims are to be accorded the broadest interpretation so as to encompass all such modifications and similar arrangements. It is to be understood that the above description is intended to be illustrative, and not restrictive. Many other embodiments will be apparent to those of skill in the art upon reading and understanding the above description. The scope of the disclosed subject matter is therefore to be determined in reference to the appended claims, along with the full scope of equivalents to which such claims are entitled.

What is claimed is:

1. A method performed by a system having at least a processor and a memory therein, comprising:
creating a first industry-specific online community space within a first of a plurality of instances of a cloud computing environment;
exporting the first industry-specific online community space to the plurality of instances of the cloud computing environment; and
creating a second industry-specific online community space, separate and distinct from the first industry-specific online community space, within one of the plurality of instances of the cloud computing environment, using the exported first industry-specific online community space as a base for creating the second industry-specific online community space.

2. The method of claim 1, wherein creating the first industry-specific online community space comprises customizing a community template and using the customized community template as a base for creating the first industry-specific online community space;
wherein exporting the first industry-specific online community space to the plurality of instances of the cloud computing environment comprises exporting a portion of the customized community template to the plurality of instances of the cloud computing environment; and
wherein creating the second industry-specific online community space using the exported first industry-specific online community space as a base for creating the second industry-specific online community space comprises using the exported portion of the customized community template as the base for creating the second industry-specific online community space.

3. The method of claim 2, wherein creating the second industry-specific online community space within one of the plurality of instances of the cloud computing environment comprises creating the second industry-specific online community space within a second of the plurality of instances of the cloud computing environment, separate and distinct from the first of the plurality of instances of the cloud computing environment,
wherein exporting the portion of the customized community template to the plurality of instances of the cloud computing environment comprises exporting the portion of the customized community template for use by the second of the plurality of instances of the cloud computing environment;
wherein exporting the portion of the customized community template for use by the second of the plurality of instances of the cloud computing environment further comprises:
packaging the exported portion of the customized community template; and
distributing the package to the second of the plurality of instances of the cloud computing environment via a private link, or uploading the package to an electronic business application storefront from which the package may imported by the second of the plurality of instances of the cloud computing environment.

4. The method of claim 2, wherein creating the first industry-specific online community space further comprises using and customizing components consisting of self-contained and reusable units of a user interface for a web application in conjunction with using the customized community template as the base for creating the first industry-specific online community space.

5. The method of claim 4, wherein creating the first industry-specific online community space further comprises using and customizing one or more of a user-interface theme layout, cascaded style sheets, web pages, and content layouts, in conjunction with using the customized community template as the base for creating the first industry-specific online community space.

6. The method of claim 3, further comprising the second of the plurality of instances of the cloud computing environment importing the uploaded package from the electronic business application storefront into the second of the plurality of instances of the cloud computing environment.

7. The method of claim 6, wherein creating the second industry-specific online community space, separate and distinct from the first industry-specific online community space, within one of the plurality of instances of the cloud computing environment, using the exported first industry-specific online community space as a base for creating the second industry-specific online community space, comprises creating the second industry-specific online community space within the second of the plurality of instances of the cloud computing environment using the imported package from the electronic business application storefront as the base for creating the second industry-specific online community space.

8. A system to execute within a host organization, wherein the system comprises:
a processor and a memory to execute instructions on the system, the instructions providing:
means for creating a first industry-specific online community space within a first of a plurality of instances of a cloud computing environment;
means for exporting the first industry-specific online community space to the plurality of instances of the cloud computing environment; and
means for creating a second industry-specific online community space, separate and distinct from the first industry-specific online community space, within one of the plurality of instances of the cloud computing environment, using the exported first industry-specific online community space as a base for creating the second industry-specific online community space.

9. The system of claim 8, wherein the means for creating the first industry-specific online community space comprises means for customizing a community template and using the customized community template as a base for creating the first industry-specific online community space;
wherein the means for exporting the first industry-specific online community space to the plurality of instances of the cloud computing environment comprises means for exporting a portion of the customized community template to the plurality of instances of the cloud computing environment; and
wherein the means for creating the second industry-specific online community space using the exported first industry-specific online community space as a base for creating the second industry-specific online community space comprises means for using the exported portion of the customized community template as the base for creating the second industry-specific online community space.

10. The system of claim 9, wherein the means for creating the second industry-specific online community space within one of the plurality of instances of the cloud computing environment comprises means for creating the second industry-specific online community space within a second of the plurality of instances of the cloud computing environment, separate and distinct from the first of the plurality of instances of the cloud computing environment,
wherein the means for exporting the portion of the customized community template to the plurality of instances of the cloud computing environment comprises means for exporting the portion of the customized community template for use by the second of the plurality of instances of the cloud computing environment;
wherein the means for exporting the portion of the customized community template for use by the second of the plurality of instances of the cloud computing environment further comprises:
means for packaging the exported portion of the customized community template; and
means for distributing the package to the second of the plurality of instances of the cloud computing environment via a private link, or uploading the package to an electronic business application storefront from which the package may imported by the second of the plurality of instances of the cloud computing environment.

11. The system of claim 9, wherein the means for creating the first industry-specific online community space further comprises means for using and customizing components consisting of self-contained and reusable units of a user interface for a web application in conjunction with using the customized community template as the base for creating the first industry-specific online community space.

12. The system of claim 11, wherein the means for creating the first industry-specific online community space further comprises means for using and customizing one or more of a user-interface theme layout, cascaded style sheets, web pages, and content layouts, in conjunction with means for using the customized community template as the base for creating the first industry-specific online community space.

13. The system of claim 10, further comprising means for the second of the plurality of instances of the cloud computing environment importing the uploaded package from the electronic business application storefront into the second of the plurality of instances of the cloud computing environment.

14. The system of claim 13, wherein the means for creating the second industry-specific online community space, separate and distinct from the first industry-specific online community space, within one of the plurality of instances of the cloud computing environment, using the exported first industry-specific online community space as a base for creating the second industry-specific online community space, comprises means for creating the second industry-specific online community space within the second of the plurality of instances of the cloud computing environment using the imported package from the electronic business application storefront as the base for creating the second industry-specific online community space.

15. Non-transitory computer readable storage media having instructions stored thereon that, when executed by a processor of a system, cause the system to perform operations including:
creating a first industry-specific online community space within a first of a plurality of instances of a cloud computing environment;
exporting the first industry-specific online community space to the plurality of instances of the cloud computing environment; and
creating a second industry-specific online community space, separate and distinct from the first industry-specific online community space, within one of the plurality of instances of the cloud computing environment, using the exported first industry-specific online community space as a base for creating the second industry-specific online community space.

16. The non-transitory computer readable storage media of claim 15, wherein the instructions stored thereon that, when executed by a processor of a system, cause the system to perform the operation of creating the first industry-specific online community space comprise instructions for customizing a community template and using the customized community template as a base for creating the first industry-specific online community space;
wherein the instructions for exporting the first industry-specific online community space to the plurality of instances of the cloud computing environment comprise instructions for exporting a portion of the customized community template to the plurality of instances of the cloud computing environment; and
wherein the instructions for creating the second industry-specific online community space using the exported first industry-specific online community space as a base for creating the second industry-specific online community space comprise instructions for using the exported portion of the customized community template as the base for creating the second industry-specific online community space.

17. The non-transitory computer readable storage media of claim 16, wherein the instructions creating the second industry-specific online community space within one of the plurality of instances of the cloud computing environment comprise instructions for creating the second industry-specific online community space within a second of the plurality of instances of the cloud computing environment, separate and distinct from the first of the plurality of instances of the cloud computing environment,
wherein the instructions for exporting the portion of the customized community template to the plurality of instances of the cloud computing environment comprise instructions for exporting the portion of the customized community template for use by the second of the plurality of instances of the cloud computing environment;
wherein the instructions for exporting the portion of the customized community template for use by the second of the plurality of instances of the cloud computing environment further comprise instructions for:
packaging the exported portion of the customized community template; and
distributing the package to the second of the plurality of instances of the cloud computing environment via a private link, or uploading the package to an electronic business application storefront from which the package may imported by the second of the plurality of instances of the cloud computing environment.

18. The non-transitory computer readable storage media of claim 16, wherein the instructions for creating the first industry-specific online community space further comprise instructions for using and customizing components consisting of self-contained and reusable units of a user interface for a web application in conjunction with using the customized community template as the base for creating the first industry-specific online community space.

19. The non-transitory computer readable storage media of claim 18, wherein the instructions for creating the first industry-specific online community space further comprise instructions for using and customizing one or more of a user-interface theme layout, cascaded style sheets, web pages, and content layouts, in conjunction with using the customized community template as the base for creating the first industry-specific online community space.

20. The non-transitory computer readable storage media of claim 17, further comprising instructions for the second of the plurality of instances of the cloud computing environment importing the uploaded package from the electronic business application storefront into the second of the plurality of instances of the cloud computing environment.

21. The non-transitory computer readable storage media of claim 20, wherein the instructions for creating the second industry-specific online community space, separate and distinct from the first industry-specific online community space, within one of the plurality of instances of the cloud computing environment, using the exported first industry-specific online community space as a base for creating the second industry-specific online community space, comprise instructions for creating the second industry-specific online community space within the second of the plurality of instances of the cloud computing environment using the imported package from the electronic business application storefront as the base for creating the second industry-specific online community space.
